(19) United States
(12) Patent Application Publication
(10) Pub. No.: US 2009/0307712 A1
(43) Pub. Date: Dec. 10, 2009

(54) ACTOR VIRTUAL MACHINE

(76) Inventor: Rex Young, Bellevue, WA (US)

Correspondence Address: PERKINS COIE LLP;PATENT-SEA, P.O. BOX 1247, SEATTLE, WA, 98111-1247, US

(21) Appl. No.: 12/135,879

(22) Filed: Jun. 9, 2008

(51) Int. Cl. G06F 9/54

(52) U.S. Cl. 719/313; 719/328

(57) ABSTRACT

An actor virtual machine is described. In various embodiments, the actor virtual machine (AVM) implements a practicable message-passing model in a computer programming language that supports components and concurrent execution. The model includes receiving by a first actor virtual machine a message from a first component wherein the received message includes no addressing information; identifying from a stored routing rule a second component to which the received message should be forwarded; and forwarding the received message to the identified second component, wherein the first actor virtual machine, the first component, and the second component are all components of an executing software application.

### BACKGROUND

Software applications and programs (“software”) are commonly implemented using multiple components. For example, an application may have a user interface component, communications component, processing component, and a storage component. The user interface component provides output to a user and collects input from a user; the communications component sends and receives communications (e.g., by using the Internet or another network); the processing component processes information; and the storage component stores information. Each such component may be implemented as one or more sub-components (also “components”). Many components of software generally communicate with each other.

Software developers commonly employ various programming techniques to enable components of applications to communicate with each other. These communications techniques are employed in parallel computing (e.g., when several components operate in parallel), object-oriented programming (e.g., when components are implemented as objects), and interprocess communications (e.g., when multiple processes operate in parallel). Examples of communications techniques include direct function invocation and message passing.

In direct function invocation, a first component invokes a function provided by a second component to communicate. For example, a first object may invoke a function provided by a second object to cause a state change in the second object. Remote procedure calls are a type of direct function invocation.

In message passing, a component sends a message that one or more other components can receive and react to. For example, a mouse driver component may send a message indicating that a user has depressed a mouse button and later send another message indicating that the user has released the mouse button. A user interface component may determine that the mouse depression and release is a “click” operation that was performed on a button that the user interface component has displayed. The mouse driver component thus can communicate mouse button information to the user interface component.

Various styles of message passing are known in the art. These include amorphous computing, antiobjects, flow-based computing, “SOAP” (originally standing for “Simple Object Access Protocol”), and an actor model.

In the actor model, actors send messages to each other. An actor can be a component. In response to a message that an actors receives, the actor can take various actions, such as processing contents of the message, creating additional actors, sending messages, etc. The Actor model originates in the following paper: Carl Hewitt; Peter Bishop and Richard Steiger, “A Universal Modular Actor Formalism for Artificial Intelligence,” International Joint Conferences on Artificial Intelligence (1973).

### BRIEF DESCRIPTION OF THE DRAWINGS

FIG. 1 is a block diagram illustrating an environment in which the system may operate in some embodiments.

FIG. 2-3B are combination flow and system diagrams illustrating processing the system performs in some embodiments.

### DETAILED DESCRIPTION

Systems and methods (“the system”) for implementing practicable message-passing models are described. In various embodiments, the system includes actor virtual machines (AVMs). An AVM is a component (e.g., an object) of an application that enables components (e.g., objects) of the application to send and receive messages in the message-passing model. A component can be a sending component (sometimes called “sender”) when it sends messages or a recipient component when it receives messages. A component can be both a sending component and a recipient component.

The AVM can provide methods (also known as functions) for components to register themselves and to send and/or receive messages. For example, a component (e.g., an object) can register with an AVM to receive messages and thereby becomes a registered recipient actor. When registering, the component can provide an identifier, a reference, a message type, and a callback method. The identifier can identify the component. As an example, the identifier can be a unique identifier that uniquely identifies the component in the space of the AVM with which the component is registered. The reference can be a reference that is native to the computing environment in which the AVM executes (e.g., a Java reference) or other reference that the AVM can use to interact with the component. Different operating environments (e.g., operating systems, runtime environments, programming languages, etc.) can employ different reference conventions. The reference can be to an already instantiated component or can represent information that the AVM can use to instantiate a new instance of a component and obtain a native reference to the newly instantiated component. The message type is a type of message that the component registers as it can handle. In various embodiments, the message type can indicate a name that is unique in the space of the component (also referred to as a message tag) and an indication of whether the message is synchronous or asynchronous. When the message is sent synchronously, the sending component awaits confirmation (e.g., a response message) that the message was sent. When the message is sent asynchronously, the sending component does not await confirmation. A component can provide one or more message types. The callback method is a function the component provides that the AVM can invoke when it receives a message that should be forwarded to a component that is registered with the AVM. In various embodiments, a component can register other components, such as by providing an identifier and reference for the other components.

Any component can send a message using an AVM. For example, any component of an application can use an AVM associated with that application to send messages without first registering with the AVM. The sending component can send a message by invoking a SendMessage method of the AVM and provide an identifier, message type, and message payload.

Sending components do not need to identify recipients for messages. An AVM that receives a message can identify recipients for incoming messages by analyzing routing rules. One or more components can register routing rules with the AVM. A routing rule can indicate sending components, recipient components, and message types. As an example, a routing rule can indicate that messages from component A having message type 1 should be routed to component B. When the AVM receives a message from component A having message type 1, it could then send the message to component B by invoking the callback method component B provided when it registered as a recipient actor. A routing rule can specify a first message type for a sending component and a second message type for a recipient actor. When the AVM receives a message from the sending component with the first message type, it can forward the message to the recipient actor and indicate the second message type. Thus, an AVM can map message types.

An AVM can receive and process requests dynamically at any time during execution. These requests can include requests to send messages, register recipients, register routing rules, and so forth. When an AVM receives an asynchronous message for which it does not have a corresponding rule or registered recipient, it can discard the message. If the message was sent synchronously, the AVM can provide an error indication (e.g., indicating that no recipient could be identified, no response was received from the recipient, timeout, etc.).

In various embodiments, although any component of an application with which an AVM is associated can register rules or send messages, only components that register with the AVM as a recipient actor can receive messages. When multiple actors can receive a message and the message was sent synchronously, the AVM may select one of the responses from the recipient actors to return to the sending component.

Multiple AVMs can interoperate. Although an application may include one AVM, it can include more. A computing environment within which an application including an AVM operates may include other applications having AVMs. As an example, two applications may execute in a computing environment wherein each application includes an AVM. Two different computing environments may each execute applications including AVMs. As an example, a UNIX computing environment may execute a Java application including an AVM and a .NET computing environment may execute a C# application including another AVM. The different computing environments may operate on the same computing system or in separate computing systems that are interconnected via a network, such as an intranet or the Internet.

When one AVM receives a message, it may forward the message to another AVM. As an example, when a first sending component sends a message to a first AVM, both of which are associated with a first application, the first AVM may determine based on a routing rule that the message should be delivered to a second component that is registered as a recipient actor with a second AVM. The first and second AVM may operate in the same or different computing environments, and in the same process (e.g., same application) or in different processes.

The first AVM may forward the message to the second AVM via a third AVM. As an example, the first AVM may not have a direct connection to the second AVM, but may have a connection to a third AVM that has a connection to the second AVM. AVMs may each store AVM trees. An AVM tree that an AVM stores indicates to which other AVMs the AVM is connected. In the example provided above in which the first AVM forwards a message to second AVM via a third AVM, the first AVM may store an AVM tree that indicates the third AVM as a “child” of the root and the second AVM as a “child” of the third AVM. The root of an AVM tree can indicate the AVM with which the AVM tree is associated. When an AVM receives a message that should be forwarded to components not associated with that AVM, it can check its AVM tree to determine how to most efficiently handle the message. An AVM tree can store various attributes of AVMs, such as identifiers, connection information, protocol information, and so forth.

Each AVM can create and manage AVM trees. As an example, when an AVM starts, it can have an AVM tree with only a root node that identifies the AVM as the root. When an AVM creates a connection to another AVM, it can modify its AVM tree. As examples, it can add additional nodes corresponding to connections it creates. An AVM can also exchange AVM trees with other AVMs it creates connections to. As an example, if AVM A creates a connection to AVM B, its AVM tree would include A as the root node, B as a child of the root node, and any other nodes in AVM B's AVM tree as descendants of the node identifying B. After exchanging or otherwise modifying its AVM tree, the AVM can prune its AVM tree to avoid repetitions or other problems that could cause communications errors. As an example, the AVM can ensure that its identifier appears in no node other than the root of its AVM tree. In some embodiments, when an AVM modifies its AVM tree (e.g., to add or remove an identified connection), the AVM can send one or more messages to other AVMs (e.g., AVMs with which it is connected) containing indications of the modifications it makes to its AVM tree. The other AVMs that receive such modification messages can then update their AVM trees accordingly. Thus, all connected AVMs can store AVM trees that are updated to accurately show created, destroyed, and changed connections.

AVMs can communicate with each other using interprocess communications, point-to-point communications, broadcast communications, and so forth.

An AVM can be written in any computer programming language that supports independently operating objects (e.g., programming languages having objects that support encapsulation, internal state, method invocation, and so forth) and concurrency (e.g., with multi-threading), such as object-oriented computer programming languages. The AVM can use techniques native to these computer programming languages to analyze rules and process messages sent by components with which the AVM is associated. As explained above, an AVM enables components to function with each other. Because AVMs can operate across computing environments, they can enable components to function with one another in a distributed manner and thus can enable implementation of distributed computing applications and tools.

Various modifications or enhancements can be made to the embodiments described above. As examples, when an AVM receives conflicting routing rules, it can replace a prior routing rule, select from among the routing rules, or perform processing according to all the routing rules but return only one response.

Conventionally, components of object-oriented programming techniques operate synchronously. When a first component invokes a method of a second component, the first component waits for the second component to complete. In some embodiments of the described system, however, the system provides message passing as a mechanism for the first component to cause other components to take an action. The first component can send messages synchronously or asynchronously. When a message is sent asynchronously, a sender of the message does not await a response to the sent message. In contrast, when a message is sent synchronously, its sender awaits a response to the message.

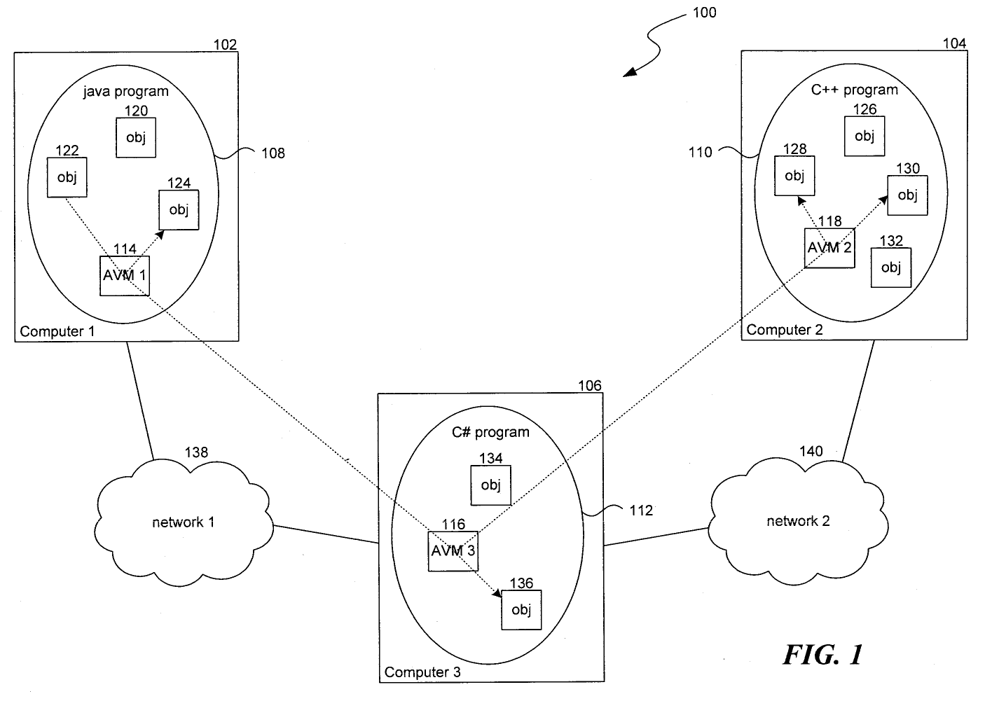

The system will now be described in further detail with reference to the figures. FIG. 1 is a block diagram illustrating an environment in which the system may operate in some embodiments. The environment can include one or more computing systems, such as computer 1 102, computer 2 104, and computer 3 106. Each computer has an associated computing environment. The computing environment can include an operating system, a runtime environment, an application, components of the application, and so forth. As examples, computer 1 102 has computing environment 108, computer 2 104 has computing environment 110, and computer 3 106 has computing environment 112. Computing environment 108 executes a java application that includes an AVM 1 114 and components (e.g., objects) 120, 122, and 124. Object 124 is registered as a recipient actor with AVM1. Computing environment 110 executes a C++ application that includes an AVM 2 118 and objects 126, 128, 130, and 132. Objects 128 and 130 are registered as recipient actors with AVM 2. Computing environment 112 executes a C# application that includes an AVM 3 116 and objects 134 and 136. Object 136 is registered as a recipient actor with AVM 3. The computing systems can be interconnected via networks, such as intranets or the Internet. As examples, computers 1, 2, and 3 are interconnected via network 1 138 and network 2 140. AVMs can exchange packets via these networks.

A packet is a data structure that contains a message or a method request and routing information. A method request is a request that a component can make to cause an AVM to invoke an identified method. The method request may indicate a method name and parameters for the indicated method. An AVM can send a message or method request to another AVM in packets. As an example, when a first AVM determines that a message should be forwarded to a recipient actor registered with a second AVM, the first AVM can wrap the message in a packet and forward the packet to the second AVM. The wrapper can include indications of the sending AVM, recipient AVM(s), and message payload. Recipient AVMs can unwrap the package and handle the message as if the message was received from a local component that sent a message directly to the AVM. In various embodiments, packets may include method requests, messages, returned messages, and “tokens.” When a packet includes a method request, it may include the method name and parameters. When a packet includes a message, it may include a message type, message payload, and indicate one or more recipients. It may also include a “token” to enable synchronization of requests and responses, and a place holder, such as for responses. When an AVM receives a packet containing a token, it can respond with a response from a local component using the received token so that the AVM that initially sent the packet can determine which packet the response packet corresponds to.

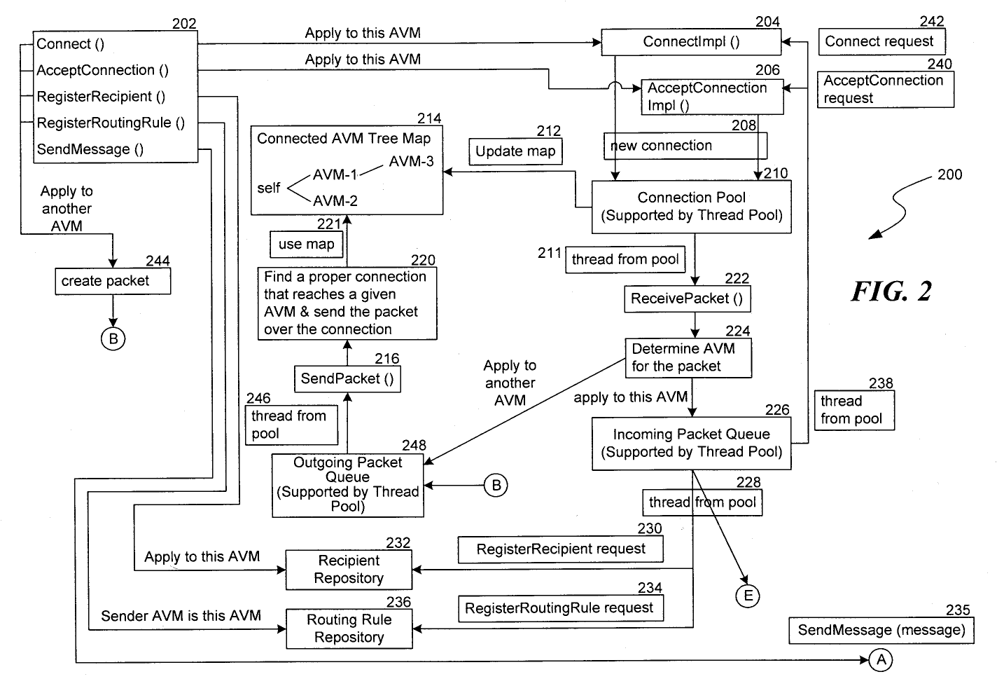

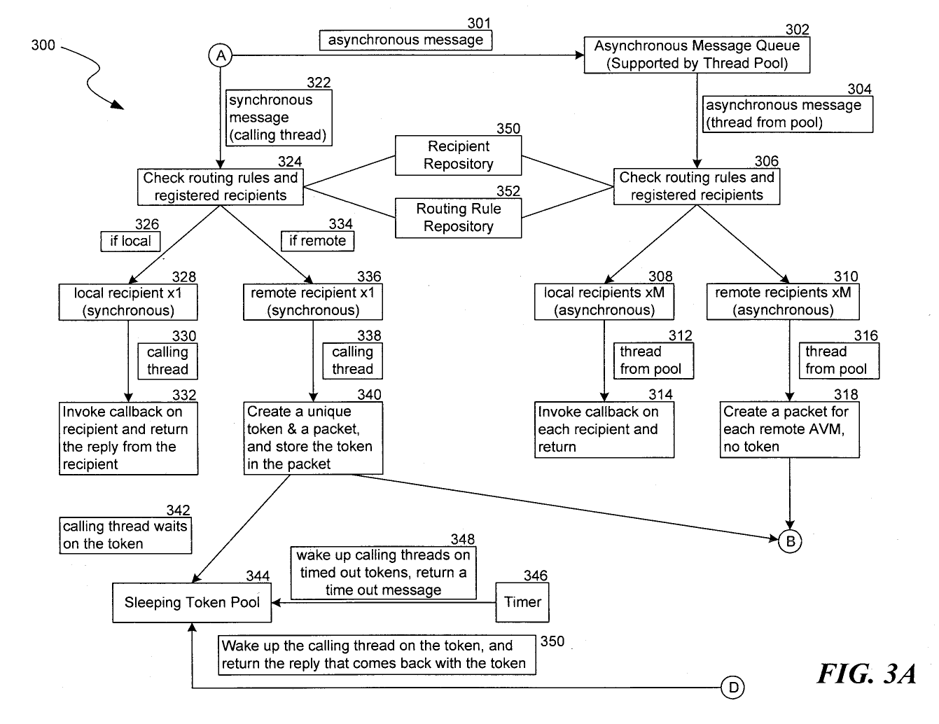

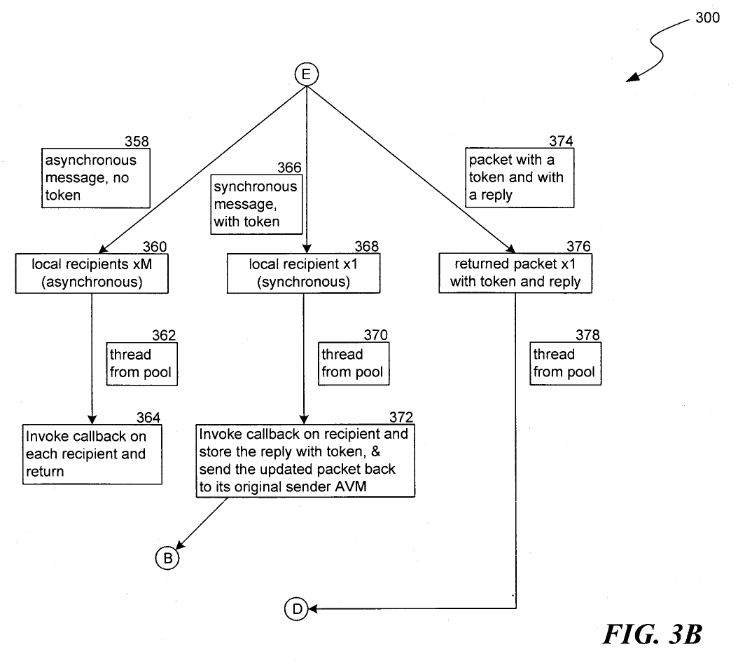

FIG. 2-3B are combination flow and system diagrams illustrating processing the system performs in some embodiments.

According to the embodiment illustrated in FIG. 2, an AVM can provide an application programming interface (API) 202. In various embodiments, the API can include Connect, AcceptConnection, RegisterRecipient, RegisterRoutingRule, and SendMessage methods. As explained above, a component can invoke a method of an AVM even though the action will be performed by a different AVM.

An object can invoke the Connect method to cause the AVM to create a connection with another AVM. In some embodiments, the object can provide an identifier, reference, or other indication for the other AVM. When an application employs a single AVM, the Connect method may not be enabled.

An object can invoke the AcceptConnection method of an AVM to cause the AVM to wait for a new incoming connection request from another AVM. As an example, a first object may request a first AVM to create a connection with a second AVM and a second object may request the second AVM to accept the connection. In some embodiments, the AcceptConnection method may receive an identifier, reference, or other indication for the other AVM.

Generally, one AVM receives a Connect request and another AVM receives an AcceptConnection request. When a connection is created, the AVMs may store appropriate indications in an AVM tree. The two AVMs may also exchange information about which AVMs they are connected to so that they can update their respective AVM trees. Once a connection is created, both AVMs will invoke their respective ReceivePacket methods (described below) to receive packets from each other.

The SendMessage method can receive as parameters an identifier for the sending component, a message type, and a message payload. The AVM can then route the message according to routing rules.

The RegisterRecipient method can receive as parameters an identifier for a recipient actor, a reference for that actor, and one or more message types. The AVM can then store the identified actor in a list of actors (e.g., recipient actor repository) that are registered with the AVM. The identifier can be used to identify the actor, such as when the AVM receives a message. The AVM can use the reference to invoke a callback method provided by the actor. The message types indicate types of messages the actor is able to handle.

The RegisterRoutingRule method can receive as parameters an identifier for a sender, a sent message type, an identifier for a recipient, and a recipient message type. The message types can also include synchronous and asynchronous. The registered rules are stored in a rules repository. Any component can register a rule. When an AVM receives a message, it forwards the message according to the rules it stores. Multiple routing rules can be stored for message types. For example, multiple components may send messages having common message types. Similarly, multiple recipient objects may handle common message types. Thus, an AVM may forward an incoming message to multiple recipient actors.

Recipient actors provide a callback method. The callback method receives parameters indicating a message type and a payload. When an AVM invokes the callback method, it can provide the message type it mapped and the payload of the message so that the recipient actor can take appropriate action on the message. The message type that the AVM provides can be one of the message types the recipient actor indicated as message types it can handle.

By sending messages to other components, a component can avoid directly invoking methods of the other components. However, when two components are already capable of directly invoking methods, they can safely continue to do so without being forced to send messages. However, when a component cannot directly invoke methods of another component (e.g., because it operates in a separate computing environment), it can employ an AVM to send and receive messages. Thus, the AVM model is compatible with direct method invocation.

By exchanging packets containing messages, the “network” of connected AVMs operate as a large, virtual AVM. One AVM can receive messages on behalf of another AVM and forward the received message to the other AVM. As an example, a component can invoke the RegisterRoutingRule of a first AVM and indicate that the rule is associated with a second AVM. The first AVM can then forward a packet containing the request message to the second AVM. Thus, the methods described above may optionally receive a parameter indicating a target AVM to which the request can be forwarded. When an AVM receives a message or request, it can check this optional parameter and forward the request (e.g., via a packet) to an indicated target AVM. If no target AVM is specified, the AVM can attempt to process the request. If the optionally specified AVM is the same AVM that received the request, the AVM can process the request. (As discussed above, an AVM can receive requests as messages or direct method invocations.)

The RegisterRoutingRule method may receive indications of the AVM with which the sending component and the recipient actor are associated. For example, the RegisterRoutingRule method may receive as additional parameters a sending AVM identifier and a recipient AVM identifier. The specified routing rule may then be registered by the identified sending AVM. When an AVM receives these indications, it can first check to see if it is the sending AVM. If so, it registers the rule. Otherwise, it forwards the request to register the rule to the identified sending AVM.

When a method of its API is invoked, the AVM determines whether the method invocation targets the AVM (“this AVM”) or a different AVM (“another AVM”). As an example, the method may identify a target AVM by providing an AVM identifier that is different from the identifier of this AVM. If the method invocation targets another AVM, the API continues at block 244.

When the method invocation targets this AVM, the API can call an implementation method corresponding to the invoked method. Each different computing environment may employ different implementation methods. As examples, the implementation for the Connect method may be different for Java and DOT-NET computing environments. When the Connect method is invoked, the API can invoke the ConnectImpl implementation method at block 204. When the AcceptConnection method is invoked, the API can invoke the AcceptConnectinImpl implementation method at block 206. An AVM may also invoke the ConnectImpl and AcceptConnectionImpl methods when the AVM receives messages containing Connect 242 and AcceptConnection 240 requests respectively from another AVM. The ConnectImpl and AcceptConnectionImpl methods create a new connection 208 and add the newly created connection indications to a connection pool 210. Upon creating a new connection, an AVM tree map 214 can be updated via a map update procedure 212. The AVM tree map 214 can indicate this AVM as a root node and connected AVMs as descendants of the root node. In the illustration, this AVM is connected to AVM 1 and AVM 2. AVM 1 is connected to AVM 3. Thus, this AVM can send packets to AVM 1 and AVM 2 directly, and can send packets to AVM 3 indirectly via AVM 1. Different connection models can also be implemented, such as in other data structures. One or more threads may each handle the active connections. As an example, a thread from a thread pool 211 may process a ReceivePacket method 222 to receive packets from other AVMs.

When a component invokes the RegisterRecipient method of this AVM's API 202, the API can add the indicated recipient's information to a recipient repository 232. The recipient repository can be implemented as a data structure that is stored in database, table, or other computer-readable medium. The recipient repository can store an identifier, a reference for the recipient actor, and other information pertaining to the component.

When a component invokes the RegisterRoutingRule method of this AVM's API 202, the API can add the indicated rule information to a routing rule repository 236. The routing rule repository can be implemented as a data structure that is stored in database, table, or other computer-readable medium. The routing rule repository can store information relating to routing rules, such as sending components, recipient components, and message types. Each rule can identify multiple message types. As an example, a sending component may send a first message type and a recipient component can receive a second message type corresponding to the first message type.

When a component invokes the SendMessage method of this AVM's API 202, the API performs the SendMessage routine 235 with the message provided in the API invocation. This method is described in further detail below at connector A of FIG. 3A.

When the API receives a parameter for a method indicating another AVM, the system creates a packet 244. The packet can identify this AVM and the other AVM by providing identifiers associated with these AVMs. The API can add the created packet to the outgoing packet queue via connector B.

The AVM can process packets in the outgoing packet queue 248 by invoking a SendPacket method 216. In various embodiments, the SendPacket method can be invoked periodically or whenever a packet is added to the outgoing packet queue. A thread from a thread pool 246 can process the SendPacket invocations. In various embodiments separate threads may process each SendPacket invocations or a set of 1 or more threads may process all SendPacket invocations. The SendPacket routine can identify a proper connection 220 to employ to send the packet by using 221 the AVM tree map 214 and sending the packet via the identified connection.

When the AVM receives a packet (e.g., from another AVM), a ReceivePacket method 222 can initially process the received packet. A thread from a thread pool 211 can process the ReceivePacket method. The ReceivePacket method 222 may determine an AVM for the received packet 224 based on a recipient indicator in the packet. If the identified recipient AVM is another AVM, the system adds the packet to the outgoing packet queue 248. If the identified recipient is this AVM, the RecievePacket routine adds the received packet to an incoming packet queue 226. The ReceivePacket method can handle packets arriving via the connection pool 210. The thread from the thread pool 211 can be a thread that is initiated by the connection pool 210 when a new packet arrives.

Threads from a thread pool 228 or 238 handle the received packets stored in the incoming packet queue. A separate thread may handle each received packet or a set of one or more threads may handle the received packets.

If the packet contains a RegisterRecipient request, the system registers the actor indicated in the payload section of the packet by placing appropriate indications in the recipient repository 232. The payload may indicate an identifier and reference for the recipient actor. The registered recipient can be associated with the process with which this AVM is associated.

If the packet contains a RegisterRoutingRule request, the system registers the routing rule indicated in the payload section of the packet by placing appropriate indications in the routing rule repository 236. The payload can indicate rule-related information, such as sending component, recipient actor, and message types.

If the packet contains an AcceptConnection request 240, the system continues at block 206 to accept a connection. If the packet contains a Connect request 242, the system continues at block 204 to place a connection request. Thus, components associated with a different AVM can request this AVM to create connections.

If the packet contains a message, the system continues at connector E of FIG. 3B.

Turning now to FIG. 3A, the SendMessage routine 300 continues at connector A. If the message type indicates an asynchronous message 301, the system continues at block 302. If the message type indicates a synchronous message 322, the system continues at block 324.

A thread from a thread pool can process the asynchronous message 304. The SendMessage method checks routing rules and registered recipients 306 to determine how to handle the message. The method can do this by checking the recipient repository 350 and the routing rule repository 352. The recipient repository 350 and the routing rule repository 352 can be the same as recipient repository 232 and routing rule repository 236 illustrated in FIG. 3A. The SendMessage method can identify rules that indicate (1) a sending component that is the same as the component that sent the message and (2) a message type that is the same as the message type indicated in the message. For each identified rule, the SendMessage method can employ the recipient repository to identify registered recipients that are registered to handle the message type indicated by the identified rule.

For identified registered recipient actors that are registered with the AVM 308, the SendMessage method can invoke the callback method for each identified recipient 314. In various embodiments, one or more threads from a thread pool 312 can invoke the callback method. For rules that identify recipients that are not registered with the AVM (e.g., remote recipients) 310, the SendMessage method can create a packet 318 to send to an AVM with which the identified recipients are registered and add the packet to an outgoing packet queue 248 (illustrated in FIG. 2) via connector B. In various embodiments, one or more threads from a thread pool 316 can invoke the callback method.

At block 324, the SendMessage method checks routing rules and registered recipients 324 to determine how to handle the message. The method can do this by checking the recipient repository 350 and the routing rule repository 352. The SendMessage method can identify rules that indicate (1) a sending component that is the same as the component that sent the message and (2) a message type that is the same as the message type indicated in the message. For each identified rule, the SendMessage method can employ the recipient repository to identify registered recipients that are registered to handle the message type indicated by the identified rule.

For identified registered recipient actors that are registered with the AVM 326, 328, the SendMessage method can invoke the callback method for each identified recipient and return the reply from the identified recipient 332. In various embodiments, thread 330 is the same thread as the thread that invoked the API. For rules that identify recipients that are not registered with the AVM (e.g., remote recipients) 334, 336, the SendMessage method can create a packet 340 to send to an AVM with which the identified recipients are registered and add the packet to an outgoing packet queue 248 (illustrated in FIG. 2) via connector B. The SendMessage routine may create a unique token and add the token to the created packet before adding the packet to the outgoing packet queue and to a sleeping token pool 344. The token can be employed to associate responses from remote components with sent requests so that the response can be forwarded to the component that made the synchronous request. In various embodiments, thread 338 is the same thread as the thread that invoked the API. The thread 338 can wait until a response is received by waiting for the token 342.

Periodically, a timer 346 may trigger threads that are waiting for responses to synchronous calls 348. If the call has timed out (e.g., because no response was received within a specified time duration), the SendMessage method may return a timeout message.

Execution continues at connector E in FIG. 3B when an AVM begins processing a packet that is waiting in the Incoming Packet Queue 226. If the packet contains an asynchronous message and has no token 358, processing continues at block 360. If the packet contains a synchronous message and has a token 366, processing continues at block 368. If the packet contains a token and also is a reply message from another AVM and/or component 374, processing continues at block 376.

At block 360, the system invokes the callback method associated with each identified recipient actor 364. One or more threads from a thread pool 362 may invoke the callback method.

At block 368, the system invokes the callback method associated with the recipient actor, stores the reply indication from the recipient actor in the packet, and places the modified packet in the outgoing packet queue 248 (illustrated in FIG. 2) via connector B so that the modified packet can be returned to the sender. One or more threads from a thread pool 370 may invoke the callback method.

At block 376, the system determines that it has received a response to a packet it previously sent with a reply (e.g., by checking the token in the packet) and triggers a thread waiting for the reply (see block 350 of FIG. 3A) via connector D. The system may associate a sleeping user thread (e.g., the thread that invoked the API) with the token by checking the sleeping token pool (see block 344 of FIG. 3A). One or more threads from a thread pool 378 may invoke the callback method.

In various embodiments, if a message or packet cannot be processed, e.g., because of insufficient data or mismatches of identifiers, the system may simply discard the message, return an error, and/or raise an exception.

In various embodiments, queues can be processed by various techniques known in the art, such as thread pools. In various embodiments, AVMs can be implemented using various software technologies, such as different computer programming languages, communications techniques, and so forth. AVMs implemented across heterogeneous systems may share a common interface but have different implementations.

In various embodiments, the system may use various networking technologies to communicate with AVMs or other network logic units. Examples include, e.g., sockets, enterprise messaging, hypertext transfer protocol (HTTP), Web services, CORBA, DCOM, RMI, etc. The contents of packets may change based on the used networking technology. As an example, when a network logic unit uses RMI, packets may be in a Java format. Alternatively, a packet may be represented in a binary format or textual format, such as in an extensible markup language (XML).

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with data structures and computer-executable instructions that implement the approval system, which means a computer-readable medium that contains the data structures and the instructions. In addition, the instructions, data structures, and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in and used with various operating environments that include personal computers, server computers, hand-held or laptop devices, multiprocessor systems, microprocessor-based systems, programmable consumer electronics, digital cameras, network PCs, minicomputers, mainframe computers, computing environments that include any of the above systems or devices, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1-20. (canceled)

21. A method performed by an actor virtual machine executing at a computing system having a processor to forward a message between a first component and a second component, comprising:
receiving by the processor executing the actor virtual machine the message from the first component;
determining a first identifier for the first component;
determining a second identifier for the second component based at least on the first identifier;
determining the second component based at least on the second identifier; and
forwarding the received message to the identified second component.

22. The method of claim 21 wherein the computing system provides one or more system functions for:
identifying a unique identifier based on a received indication of a component; and
identifying a particular component based on a received identifier.

23. The method of claim 22 further comprising receiving a routing rule, the routing rule specifying (a) the first identifier for a sending component and (b) the second identifier for a receiving component, wherein the determining the second identifier for the second component based at least on the first identifier includes:
identifying based at least on the first identifier the routing rule; and
identifying from the routing rule the second identifier.

24. The method of claim 21 wherein the actor virtual machine, the first component, and the second component are objects specified in an object-oriented programming language.

25. The method of 24 wherein the receiving the message is implemented by the first component invoking a send method provided by the actor virtual machine; and the forwarding the received message is implemented by the actor virtual machine invoking a callback method provided by the second component.

26. The method of 25 wherein a first thread used by the first component to invoke the send method provided by the actor virtual machine is different from a second thread used by the actor virtual machine to invoke the callback method provided by the second component.

27. The method of claim 24 wherein the determining a first identifier for the first component includes identifying the first identifier based at least on the first component, wherein the first identifier is previously registered for the first component with the actor virtual machine.

28. The method of claim 24 wherein the determining a first identifier for the first component includes generating the first identifier based at least on the message or identification of the first component.

29. The method of claim 24 wherein the determining a first identifier for the first component includes receiving the first identifier from the first component.

30. The method of claim 24 further comprising receiving a registration request for the second component, the request specifying (a) the second identifier, (b) the second component and (c) a callback method provided by the second component, wherein the determining the second component based at least on the second identifier includes identifying the registration based at least on the second identifier.

31. The method of claim 24 further comprising receiving a routing rule, the routing rule specifying (a) the first identifier for a sending component and (b) the second identifier for a receiving component, wherein the determining a second identifier for the second component based at least on the first identifier includes:
identifying the routing rule based at least on the first identifier; and
identifying the second identifier from the routing rule.

32. The method of claim 31 further comprising receiving a registration request for the second component, the request specifying (a) the second identifier, (b) the second component and (c) a callback method provided by the second component, wherein the determining the second component based at least on the second identifier includes identifying the registration based at least on the second identifier.

33. The method of claim 32 wherein the determining a first identifier for the first component includes receiving the first identifier from the first component.

34. The method of 33 wherein the receiving the message is implemented by the first component invoking a send method provided by the actor virtual machine; and the forwarding the received message is implemented by the actor virtual machine invoking the callback method provided by the second component.

35. The method of 34 wherein a first thread used by the first component to invoke the send method provided by the actor virtual machine is different from a second thread used by the actor virtual machine to invoke the callback method provided by the second component.

36. A method performed by an actor virtual machine executing at a first computing system having a processor to receive a message from a first component and forward the message to a proxy wherein the proxy (a) identifies a second component based at least on a second identifier, and (b) forwards the message to the second component, comprising:
receiving by the processor executing the actor virtual machine the message from the first component;
determining a first identifier for the first component;
determining based at least on the first identifier the second identifier for the second component;
determining the proxy for the second component; and
forwarding the received message and the second identifier to the identified proxy.

37. The method of claim 36 wherein the proxy is a third component.

38. The method of claim 36 wherein the proxy is a second actor virtual machine that is configured to communicate with the actor virtual machine executed by the processor.

39. The method of claim 36 wherein the proxy executes at a second computing system that is different from the first computing system.

40. The method of claim 36 wherein the actor virtual machine and the first component are objects specified in a first object-oriented programming language, and both execute within a first process.

41. The method of claim 40 wherein the proxy and the second component are objects and execute within the first process.

42. The method of claim 40 wherein the proxy and the second component are objects specified in a second object-oriented programming language and execute with a second process that is different from the first process.

43. The method of claim 40 wherein the proxy and the second component execute at a second computing system that is different from the first computing system.

44. The method of claim 40 wherein the determining a first identifier for the first component includes identifying the first identifier based at least on the first component, wherein the first identifier is previously registered with the actor virtual machine for the first component.

45. The method of claim 40 wherein the determining a first identifier for the first component includes generating the first identifier based at least the message or identification of the first component.

46. The method of claim 40 wherein the determining a first identifier for the first component includes receiving the first identifier from the first component.

47. The method of claim 40 further comprising receiving information to enable communication with the proxy.

48. The method of claim 47 wherein receiving information to enable communication with the proxy includes:
receiving a meta data for the proxy; and
establishing a communication with the proxy using the meta data.

49. The method of claim 40 further comprising:
receiving a routing rule, the routing rule specifying (a) the first identifier for a sending component and (b) the second identifier for a receiving component, wherein the determining the second identifier for the second component based at least on the first identifier includes:
identifying the routing rule based at least on the first identifier; and
identifying the second identifier from the routing rule.

50. The method of claim 49 wherein the determining a first identifier for the first component includes receiving the first identifier from the first component.

51. The method of claim 50 further comprising receiving information to enable communication with the proxy.

52. A computer-readable medium storing computer-executable instructions that, when executed, perform a method for receiving a message from a first component and forward the message to a proxy wherein the proxy (a) identifies a second component based at least on a second identifier, and (b) forwards the message to the second component, the method comprising:
receiving the message from the first component;
determining a first identifier for the first component;
determining based at least on the first identifier the second identifier for the second component;
determining the proxy for the second component; and
forwarding the received message and the second identifier to the identified proxy.

53. A computer-readable medium storing computer-executable instructions that, when executed, perform a method for forwarding a message between a first component and a second component, comprising:
receiving the message from the first component;
determining a first identifier for the first component;
determining a second identifier for the second component based at least on the first identifier;
determining the second component based at least on the second identifier; and
forwarding the received message to the identified second component.
